(19) United States
(12) Patent Application Publication
(10) Pub. No.: US 2004/0145091 A1
(43) Pub. Date: Jul. 29, 2004

(54) Composite urethane pipe and method of forming same

(76) Inventors: John T. Willig, Cincinnati, OH (US); Nicholas P. Bitter, West Chester, OH (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/752,469

(22) Filed: Jan. 6, 2004

Related U.S. Application Data
(60) Provisional application No. 60/440,231, filed on Jan. 15, 2003.

(51) Int. Cl. B29C 70/42; B29C 41/04; B29C 41/20

(52) U.S. Cl. 264/510; 264/236; 264/334; 264/257; 264/103; 264/265; 264/311; 264/512

(57) ABSTRACT

A method of forming a reinforced urethane product having a urethane wear layer and a integral reinforcing member. A reinforcing member is formed from a woven fiber material that has a shape generally corresponding to the desired urethane product, such as a composite urethane pipe. The reinforcing member is initially stiffened through application of a sizing compound. Once stiffened, the reinforcing member is inserted into a mold and a supply of urethane is forced outward toward the inner wall of the mold cavity such that the urethane penetrates into the woven fibers of the reinforcing member. The urethane is cured in the mold and the completed reinforced urethane product is removed from the mold for use. The liquid urethane is preferably forced outward within the mold through application of either a centrifugal force or the application of positive pressure.

### CROSS REFERENCE TO RELATED APPLICATION

The present application is based on and claims priority to U.S. Provisional Patent Application Serial No. 60/440,231, filed on Jan. 15, 2003.

### BACKGROUND OF THE INVENTION

The present invention generally relates to the use and manufacture of reinforced urethane pipe sections and other molded shapes for reducing the overall weight of a product while providing the required strength and durability. More specifically, the present invention is a method of creating a section of reinforced urethane pipe that can be used with concrete pumping units to reduce the overall weight of the pipe while providing the required strength and durability for the delivery of concrete or other materials.

Presently, fabricated metal shapes, such as pipes, cyclones, elbows and chutes, are used to process abrasive materials such as sand, coal, concrete, iron ore slurry, sugar, salt, corn and phosphate. Urethane provides improved wear life in many of these abrasive applications. However, due to the pressures associated with some processes, urethane is not a viable alternative and steel is still used. Steel and other metals have inherent strength and stiffness properties that enable metal products to support heavy loads and large internal forces. For example, slurry solutions are often pumped in steel pipe under several hundred pounds per square inch (psi) of pressure. These pressures would cause unsupported urethane pipe to expand like a balloon and burst.

There exist many examples of where urethane is supported by steel or metal structures, where the metal is used to provide support and strength. However metal fabricated structures still add cost and weight, which detracts from many of the advantages of the urethane itself.

Therefore, a need exist to develop a urethane product having the required structural strength properties. If a method were developed to reinforce urethane with a high strength fiber integral to a molded shape, such a product would have great appeal. This combination of materials or composite structure would have significant weight and fabrication cost advantages over a metal or steel structure. Further, an opportunity exist for additional cost savings due to elimination of secondary operations typical of metal fabrications, such as welding, painting, and machining. For example, bolt holes and slots could be molded directly into the product, along with part numbers and company logos. Additionally, since urethane does not rust, secondary painting could also be eliminated.

Yet further, the possibility of part consolidation exists as a significant benefit, since a molded urethane part could incorporate complex shapes, and detail with little or no additional cost.

### SUMMARY OF THE INVENTION

The present invention is directed to a method of reinforcing urethane with a braided reinforcing layer of high strength fiber. The reinforced urethane product has many potential uses, such as creating a composite pipe section that results in a dramatic weight reduction as compared to steel pipe sections while providing the required wear resistance and strength to withstand the pressures associated with pumping concrete.

Each of the composite products, such as a section of pipe, includes a reinforcing outer layer and a wear resistant inner layer. The reinforcing outer layer provides the required hoop or tensile strength to withstand the internal pressure within the product, such as concrete being pumped. The wear resistant inner surface provides the required durability for contact with the material inside the product, such as concrete being pumped.

In the preferred embodiment of the invention, the reinforcing layer is formed from a braided or woven sock of a fiber material, such as carbon fiber. The wear resistant inner layer is preferably formed from urethane having a durometer hardness rating of between 90-A and 95-A. However, other hardness ratings are contemplated depending upon the type of material being pumped.

In accordance with the present invention, each of the reinforced composite pipe sections utilizing a braided carbon fiber sock and urethane weighs approximately 25% of a similar steel pipe. Thus, the carbon fiber reinforced urethane pipe sections have a weight of approximately 2.6 pounds per foot, as compared to approximately 10.2 pounds per foot for a steel pipe.

Typical fibers used in composites are glass, carbon, and aramid (Kevlar™). Some lesser known fibers include, but are not limited to, Vectron™, basalt, and UHMWPE fibers (ultra high molecular weigh polyethylene). Currently, there exist no suitable way to integrate a high strength fiber with urethane-molded shapes such as pipe, chutes, and hydro-cyclones. Cast urethanes, by their nature, have high molecular weights and are very thick (viscous) when processed, thus making it difficult to reinforce with a fiber.

The present invention relates to a method of orienting high strength fibers into a preferred position and processing the urethane so that it maximizes its role as a binding matrix while providing the desired wear resistance. This invention demonstrates methods to ensure that the braided fibers are saturated with the urethane. Further it presents a method to ensure the fibers maintain their preferred orientation which is critical to achieving the desired physical strength where needed.

The reinforced urethane product, such as a pipe section, of the present invention is preferably formed by first supplying a braided sock formed from a fiber material, such as carbon fiber. Typically, the braided sock is tubular in nature and collapses upon itself when positioned along either a horizontal axis or a vertical axis. The braided sock is supported along a mandrel and a sizing compound is applied to the exterior surface of the braided sock to stiffen the sock such that the sock is able to maintain a desired shape.

Once the woven sock has been stiffened, the sock is placed within a mold having an inner wall having an inner shape approximately equal to the outer shape of the stiffened braided sock. Once the braided sock has been placed into the mold, the mold is heated and a supply of mixed, uncured liquid urethane is poured into the open interior defined by the braided sock. The amount of urethane poured into the mold determines the thickness of the wear resistant inner layer of the final product.

Once the liquid urethane has been poured into the braided sock in the mold, the mold is rotated about a horizontal axis at approximately 1000 RPM's to create a centrifugal force that presses the urethane outward toward the braided sock. Since the braided sock is heavier than the urethane, the braided sock is pressed against the inner wall of the mold and the urethane penetrates the weave of the braided sock.

Alternatively, a supply of positive pressure can be connected to the enclosed mold to force the urethane and the braided sock outward toward the inner wall of the mold. In each case, the urethane penetrates the fibers of the braided sock.

Once the urethane is exposed to sufficient heat and time, it will partially cure enough to allow the reinforced composite pipe to be removed. Once the tube has been removed, the tube is post cured in an oven.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is a perspective view of a section of reinforced composite pipe formed in accordance with the present invention;

FIG. 2 is a section view illustrating the formed, reinforced composite pipe;

FIG. 3 is a perspective view of the woven fiber sock used to form the reinforcing layer of the pipe section of the present invention;

FIG. 4 is a perspective view illustrating the application of the fiber sock to a forming mandrel;

FIG. 5 is a perspective view illustrating the application of the stiffening layer to the braided sock;

FIG. 6 is a perspective view illustrating the positioning of stiffened, braided sock within a mold;

FIG. 7 is a section view taken along line 7-7 of FIG. 6 illustrating the stiffened reinforcement sock within the mold;

FIG. 8 is a perspective view illustrating the pouring of the liquid urethane into the mold; and

FIG. 9 is a partial section view illustrating the heating of the mold and composite pipe to set the urethane.

### DETAILED DESCRIPTION OF THE INVENTION

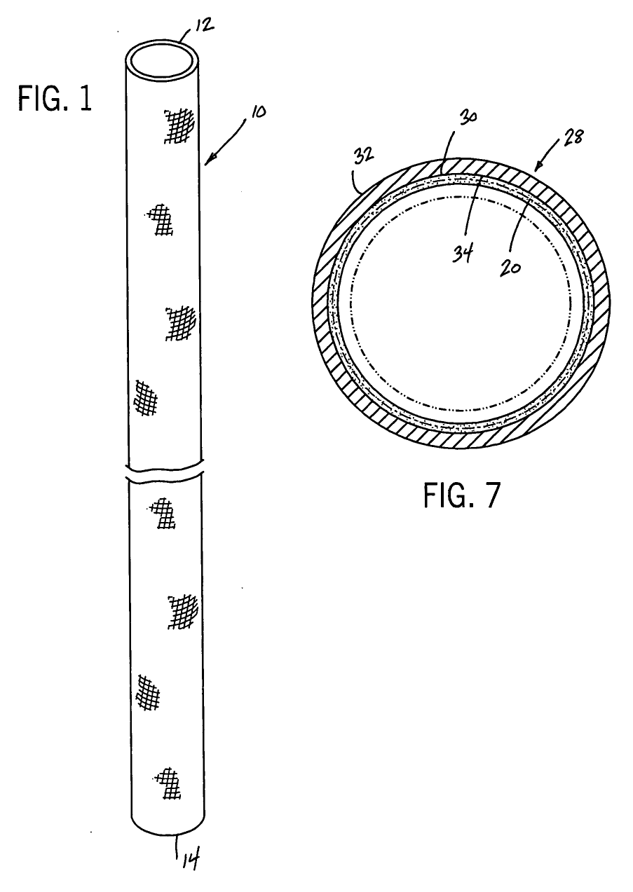

Referring first to FIG. 1, thereshown is a reinforced composite pipe section 10 that forms the basis of the present invention. The pipe section 10 extends from a first end 12 to a second end 14 to define the overall length of the pipe section 10. In the preferred embodiment of the invention, the length of the pipe section 10 is three meters, although other lengths of pipe are certainly contemplated as being within the scope of the present invention.

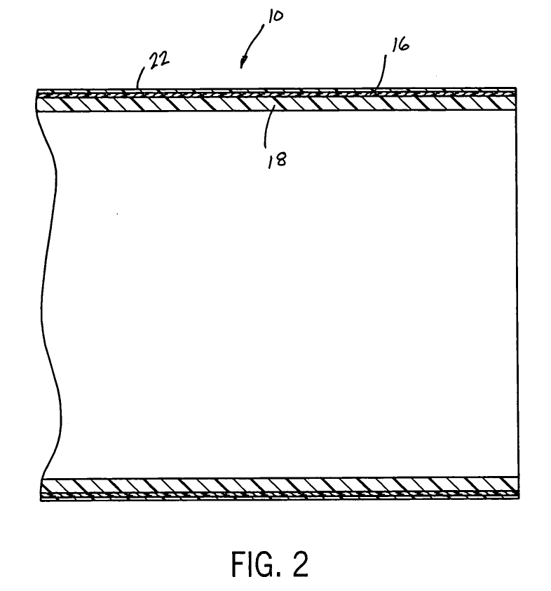

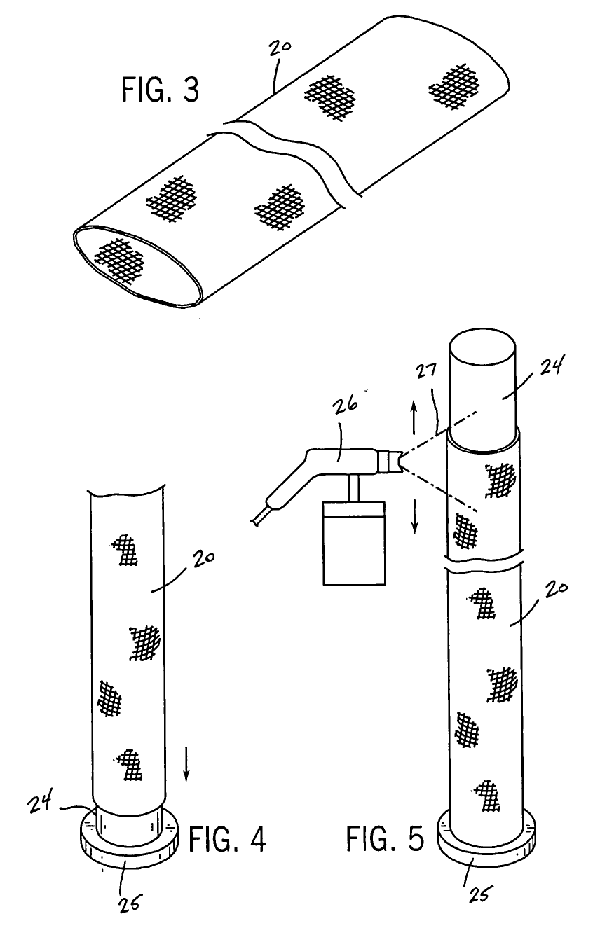

Referring now to FIG. 2, thereshown is a cross-section view of the reinforced pipe section 10 of the present invention. The reinforced pipe section 10 includes a reinforcing layer 16 and a wear resistant inner layer 18. In the preferred embodiment of the invention, the reinforcing layer 16 is a braided or woven sock 20, such as illustrated in FIG. 3. The braided sock 20 can be made from any type of fiber material, such as fiberglass, carbon fiber or a synthetic fiber such as Kevlar® or Vectran®. In the preferred embodiment of the invention, the braided sock 20 is formed from a carbon fiber material due to its weight and strength characteristics. The braided sock 20 provides for increased tensile strength for the reinforced pipe section 10 while providing for a low overall weight.

In the embodiment of the invention illustrated, the braided sock 20 has an approximate thickness of ⅛ inches and is created using a cross-hatch pattern to provide support for radial expansion of the pipe. This type of pattern is selected since the pressure generated during delivery of materials is extremely high and the cross-hatch pattern provides additional strength against radial rupture. For example, the pressure generated in a concrete boom pipe can be up to 1200 psi. Since the pipe section is typically designed to have a safety factor of around two (2400 psi), the reinforced pipe section 10 should be able to withstand this pressure. The reinforcing layer 16 provides the hoop (or tensile) strength required, while the wear layer 18 provides a high wear resistant inner surface for the flow of rough materials, such as concrete.

The braided sock 20 shown in FIG. 3 provides a shape in which the fibers of the sock are continuous and provide the most optimal orientation, specifically in parts where there is an inner and outer surface such as a pipe, a cone or an elbow. The braided sock 20 can be stretched or compressed to fit tightly onto a surface, regardless of the exact shape of the surface. For example, the braided sock 20 can be stretched to accommodate changes in angles, diameters or irregular surfaces. Specific examples include a pipe elbow, a cone or chute transitioning from a square hole to a round hole. Further, the bi-axial braided sock 20 shown in FIG. 3 can be produced inexpensively in long lengths and can be cut to a desired length as desired.

Although the present invention will be described in particular detail as a method of forming a section of composite pipe, it should be understood that various other shapes can be formed while operating within the scope of the present invention. In such embodiments, the braided sock 20 can be braided into other configurations, such as a conical section, a right angle, a spherical section as well as square, rectangular and moon shaped sections. The specific configuration of the braiding process allows the braided sock 20 to configure to a mold shape such that less stretching and manipulation is required. As illustrated in FIG. 3, in its natural form, the braided sock is limp and has little definition in an unsupported state.

Referring back to FIG. 2, if a braided sock 20 is used as the reinforcing layer 16, a stiffening layer 22 must be applied to the braided sock to stiffen the braided sock during the formation process to be described in greater detail below.

In the preferred embodiment of the invention illustrated, the wear layer 18 has a thickness of approximately 3/16 inches and is formed from a durable resin, such as urethane. The urethane wear layer 18 provides the required wear and abrasion resistance while providing low overall weight for the reinforced pipe section 10. Urethane, and other chemicals similar thereto, are available in a number of different hardnesses and chemistries. The actual formulation and hardness of the urethane wear layer 18 can be adapted depending upon the type of material flowing through the reinforced pipe section 10. In the preferred embodiment of the invention, urethane having a durometer hardness rating of 90-A to 95-D are selected. However, it is contemplated that for a non-concrete piping application, the urethane could have a durometer hardness rating as low as 70-A, or as high as 75-D.

Although the urethane used for the wear layer 18 is contemplated as having hardness range of between 70-A to 70-D, softer versions of urethane as low as 50-A can be employed as long as the structural requirements are not mandated. The softer the durometer hardness, the lower the stiffness and strength of the composite pipe or structure.

The reinforced composite pipe sections constructed in accordance with the present invention utilizing urethane and a braided fiber sock weigh roughly 25% of the currently used steel pipe sections. For example, the composite pipe section 16 has a weight of approximately 2.6 pounds per foot, while a similar steel pipe has a weight of approximately 10.2 pounds per foot. Thus, in a concrete pumping application having a boom arm with an extended length of 200 feet, the pumping boom would realize a reduction in boom force of approximately 152,000 ft. pounds. Due to the significant reduction in overall weight, lighter materials can be used to fabricate each boom section and the overall length of the boom arm can be increased. This provides a significant advantage currently not available.

The method of forming the reinforced pipe section 10 will now be described. Initially, the braided sock 20 is stretched over a mandrel 24 to provide the desired circular cross-section shape for the sock, as is shown in FIG. 4. The mandrel 24 includes an expanded diameter end 25 to correctly position the braided sock 20 along the axial length of the mandrel 24. Before it is stretched over the mandrel 24, the braided sock 20 is flexible and collapses upon itself when positioned along either a vertical axis or a horizontal axis.

After the braided sock 20 is stretched over the mandrel 24, a sizing compound 27 is applied to the braided sock 20 to provide stiffness to the sock as shown in FIG. 5. In the preferred embodiment of the invention, the sizing compound is either an epoxy or urethane, although the particular selection of the type of epoxy or urethane can vary. The sizing compound acts like a starch to stiffen the braided sock 20 into the shape of a tube. Once the sizing compound 27 has cured, the braided sock 20 forms a tube that is self supporting and will not collapse upon itself when positioned along either a vertical axis or a horizontal axis.

As illustrated in FIG. 5, the sizing compound is applied to the sock 20 while supported on the mandrel 24 by a spray applicator 26. The spray applicator moves up and down along the axial length of the mandrel 24 to supply a coating of the sizing compound. In the preferred embodiment of the invention, the sizing compound 27 is an epoxy solution diluted with a solvent. After the braided sock 20 has been sufficiently wetted with the sizing compound, the epoxy is allowed to harden such that the epoxy stiffens the braided sock 20 to form a self supporting tube.

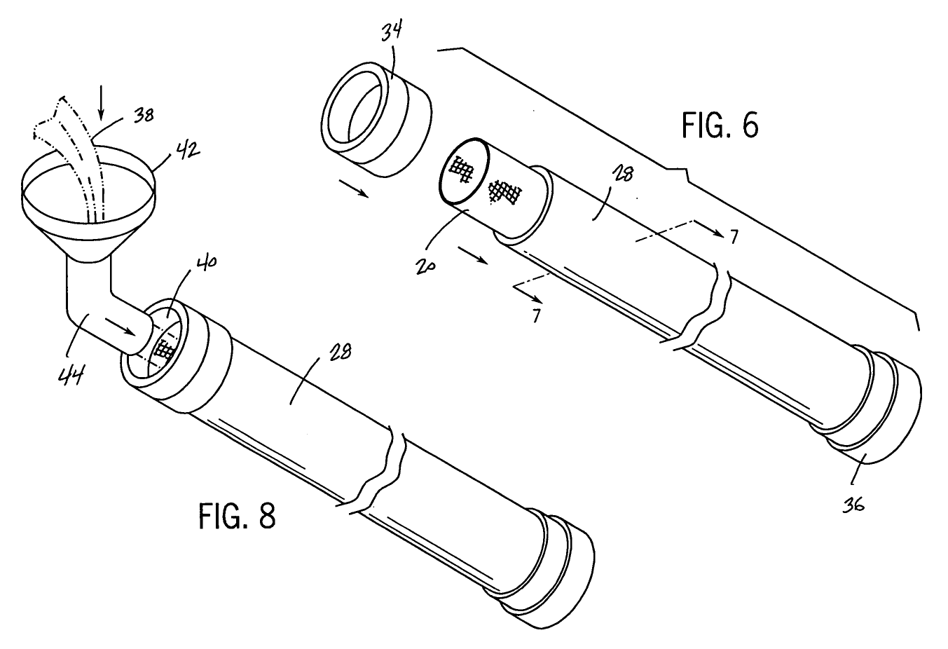

Once the braided sock 20 has been stiffened, the braided sock 20 is placed into a mold 28, as illustrated in FIG. 6. In the preferred embodiment of the invention, the mold 28 is a steel pipe that has a polished inner wall 30 and an outer wall 32, as illustrated in FIG. 7. The mold 28 preferably has a length slightly greater than the length of the reinforced pipe section to be formed such that the stiffened braided sock 20 can be contained completely within the mold 28. As illustrated in FIG. 7, the braided sock 20 has an outer diameter 34 that closely corresponds to the diameter of the inner wall 30 of the mold 28. Thus, the braided sock 20 will be supported within the inner area defined by the mold 28.

In the preferred embodiment of the invention, the diameter of the inner wall 30 of the mold 28 is slightly larger than the diameter of the braided sock 20. Specifically, the inner diameter of the mold has a diameter of approximately 0.030 inches greater than the diameter of the braided sock 20, which makes installation of the starched sock 20 into the mold easier and also allows for more efficient removal of the braided sock from the mold upon completion of the composite pipe.

Referring back to FIG. 6, once the braided sock 20 has been inserted into the mold 28, a mold end piece 36 is installed. The combination of the mold 28 and the end pieces 34, 36 completely enclose the braided sock 20 within the interior of the mold.

Once the stiffened sock 20 is inserted into the mold 28, the entire mold 28 is heated to a temperature of approximately 230° F. After heating, a supply of liquid urethane 38 is inserted into an end 40 of the mold 28 as illustrated in FIG. 8. The supply of liquid urethane 38 preferably is fed through a funnel 42 and connecting pipe 44 and allowed to flow along the axial length of the mold 28. At the elevated temperatures of approximately 230° F., the viscosity of the urethane is reduced, which allows the urethane to flow easier along the length of the mold 28. Although the embodiment shown in FIG. 8 contemplates the simple insertion of the liquid urethane 38, it is contemplated that the urethane may be pumped into the mold interior 28 under pressure depending upon the specific shape of the actual mold 28.

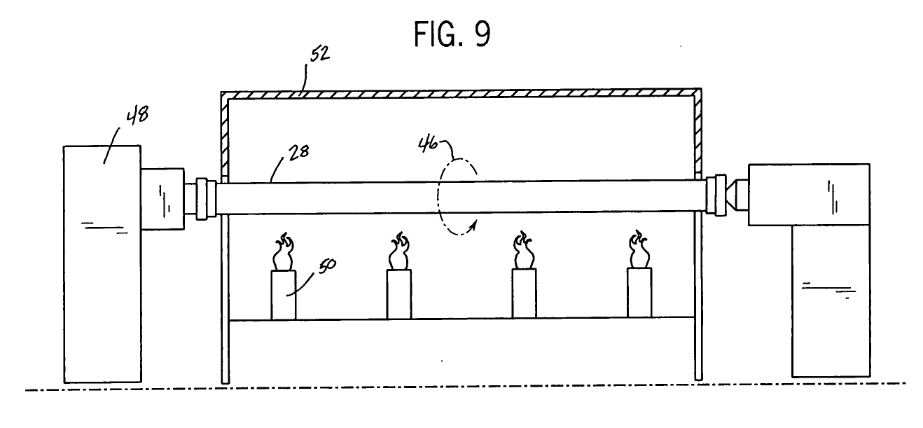

As illustrated in FIG. 9, the mold 28 extends along a horizontal axis and is rotatable about the horizontal axis, as illustrated by arrows 46. In the preferred embodiment of the invention, the mold 28 is secured to a machine 48 that can spin the mold 28 at selected speeds depending upon the thickness and viscosity of the urethane used to penetrate the braided sock and create the wear layer 42.

In the preferred embodiment of the invention, the machine 48 includes several heating elements 50 contained within an enclosed, insulated housing 52. The heating elements 50 elevate the temperature of the mold and urethane to allow the urethane to properly flow into the woven sock and ultimately to cause the urethane to set.

Initially, the mold 28 is heated to an elevated temperature prior to insertion of liquid urethane into the mold interior. In a preferred embodiment of the invention, the mold 28 is heated and the supply of liquid urethane is poured into the end of the mold, as illustrated in FIG. 8. The amount of urethane poured into the mold 28 depends upon the desired wall thickness for the wear layer 42 illustrated in FIG. 2.

Once the desired amount of liquid urethane has been poured into the mold, the speed of rotation of the mold 28 is increased such that the spinning mold 28 creates a centrifugal force. In the preferred embodiment of the invention, the mold is rotated at approximately 1000 RPM's to generate the required centrifugal force. Since the braided sock in the mold is heavier than the urethane, the braided sock is forced against the inner wall of the mold while the centrifugal force acting on the urethane applies pressure to force the urethane material to “wet” into the fibers of the braided sock and form an inside pipe liner or wear layer. Any air pockets that are contained within the urethane are driven to the center to provide a porosity free part. Once again, the thickness of the wear layer 42 is controlled by the amount of urethane poured into the mold.

After approximately 30 minutes of rotation and exposure to heat, the urethane within the mold 28 becomes cured enough to allow the tube formed from the combination of the braided sock and the urethane wear layer to be removed from the mold 28. Once the combination of the braided sock and the urethane wear layer has been removed, the tube is post cured in an oven for several hours to fully cure the urethane.

Although the present invention has been described as including only a urethane wear layer within the braided sock that forms the reinforcing layer, it is contemplated by the inventor that prior to the pouring of the urethane into the mold, a resin such as epoxy or polyester can be poured into the mold and allowed to mix with the stiffened braided sock. These resins provide higher composite tensile strength and sheer modulus properties. The urethane resin would then be poured over these resins to provide the desired wearability properties. The resin layer may provide additional durability to the braided sock and increase the hoop strength of the pipe section.

Although the present invention has been particularly described as a method of forming a composite pipe section, the same principles and essence of the invention can be applied to other shapes. However, instead of using centrifugal force to “wet out” the fibers of the braided sock, other types of pressure are contemplated as being used to direct the urethane into the desired areas of a mold. Such supply of pressure can be generated by an external pump or high pressure air. In each case, the braided sock is starched to a predetermined and desirable shape placed in the mold where the liquid urethane is forced into the fibers of the braided sock. The result is a composite urethane structure having the desired strength and durability, as described above.

Various alternatives and embodiments are contemplated as being within the scope of the following claims particularly pointing out and distinctly claiming the subject matter regarded as the invention.

We claim:

1. A method of forming a reinforced urethane product comprising the steps of:
providing a reinforcing member formed from a woven fiber material and having a shape generally corresponding to the product;
placing the reinforcing member into a mold having an inner wall, wherein an exterior surface of the reinforcing member is placed adjacent to the inner wall of the mold;
supplying an amount of liquid urethane into the mold;
forcing the urethane toward the inner wall of the mold such that the urethane penetrates the woven fiber material;
curing the urethane in the mold; and
removing the reinforced urethane product from the mold.

2. The method of claim 1 wherein the reinforcing member is formed from carbon fiber.

3. The method of claim 2 wherein the reinforcing member is braided.

4. The method of claim 1 further comprising the step of applying a sizing compound to the reinforcing member to stiffen the reinforcing member.

5. The method of claim 4 wherein the sizing compound is applied to the reinforcing member prior to insertion of the reinforcing member into the mold.

6. The method of claim 4 wherein the sizing compound is an epoxy resin.

7. The method of claim 1 wherein the step of forcing the urethane toward the inner wall of the mold includes rotating the mold to create a centrifugal force that forces the urethane toward the inner wall of the mold.

8. The method of claim 1 wherein the step of forcing the urethane toward the inner wall of the mold includes supplying a source of positive pressure to the interior of the mold to force the urethane toward the inner wall of the mold.

9. The method of claim 1 wherein the urethane is cured in the mold by heating the exterior of the mold.

10. The method of claim 1 wherein the amount of urethane supplied into the mold creates an inner wear layer having a desired thickness.

11. The method of claim 10 wherein the urethane has a durometer hardness rating between 70-A and 70-D.

12. A method of forming a reinforced pipe section comprising the steps of:
providing a braided sock formed from a woven fiber material;
placing the braided sock into a cylindrical mold having an inner wall, wherein an exterior surface of the braided sock is placed adjacent to the inner wall of the cylindrical mold;
pouring a supply of liquid urethane into the mold;
forcing the urethane outward toward the inner wall of the mold such that the urethane is forced into the woven fibers of the braided sock;
curing the urethane in the mold; and
removing the reinforced pipe from the mold.

13. The method of claim 12 wherein the braided sock is formed from carbon fiber.

14. The method of claim 12 wherein the step of forcing the urethane outward toward the inner wall of the mold includes rotating the mold about a horizontal axis to create a centrifugal force that forces both the braided sock and the urethane toward the inner wall of the mold.

15. The method of claim 14 wherein the urethane is cured in the mold by heating the exterior of the mold as the mold is rotated about the horizontal axis.

16. The method of claim 12 wherein the liquid urethane has a durometer hardness rating between 70-A and 70-D.

17. The method of claim 12 further comprising the step of applying a sizing compound to an exterior surface of the braided sock to stiffen the braided sock.

18. The method of claim 17 wherein the sizing compound is applied to the braided sock prior to the insertion of the braided sock into the mold.

19. The method of claim 15 wherein the supply of urethane creates an inner wear layer having a desired thickness.

20. The method of claim 17 further comprising the step of positioning the braided sock over a mandrel prior to applying the sizing compound to the exterior surface of the braided sock.

21. The method of claim 20 further comprising the step of removing the braided sock from the mandrel prior to insertion of the braided sock into the mold.

22. The method of claim 17 wherein the sizing compound is an epoxy solution.
